(19) United States
(12) Patent Application Publication
(10) Pub. No.: US 2024/0051233 A1
(43) Pub. Date: Feb. 15, 2024

(54) METHOD FOR PRINTING A 3D OBJECT IN A PHOTOREACTIVE COMPOSITION, AND PRINTER SUITABLE FOR IMPLEMENTING THE METHOD

(71) Applicants: UNIVERSITE CLAUDE BERNARD LYON 1, Villeurbanne (FR); CENTRE NATIONAL DE LA RECHERCHE SCIENTIFIQUE, Paris 16 (FR); ECOLE NORMALE SUPERIEURE DE LYON, Lyon 7eme (FR); INSTITUT MINES TELECOM, Palaiseau (FR)

(72) Inventors: Patrice Baldeck, Vizille (FR); Azeddine Tellal, Villeurbanne (FR); Kevin Heggarty, Lanrivoare (FR)

(21) Appl. No.: 18/264,816

(22) PCT Filed: Feb. 9, 2022
(86) PCT No.: PCT/EP2022/053176

§ 371 Date: Aug. 9, 2023

(30) Foreign Application Priority Data
Feb. 9, 2021 (FR) FR2101233

(51) Int. Cl. B29C 64/393; B33Y 10/00; B29C 64/129; B33Y 50/02; B29C 64/264

(52) U.S. Cl. CPC B29C 64/393; B33Y 10/00; B29C 64/129; B33Y 50/02; B29C 64/264

(57) ABSTRACT

A method—for printing a 3D object, defined by a 3D image having multiple illuminated points, in a photoreactive composition volume—includes extracting from the image a mosaic sequence. Each mosaic includes multiple solid areas, each including illuminated point(s). The mosaic sequence is projected in an axial direction, inside the volume, to form—from each projected mosaic—multiple light areas, each corresponding to a solid area of the projected mosaic. In the solid area of a mosaic, a number of illuminated points and the distribution of the illuminated points are adjusted so, when projecting the mosaic is into the volume, the light area corresponding to the solid area causes a photoreaction in an associated composition block with a desired axial resolution. In the same mosaic, the solid areas are distributed such that, when projecting the mosaic into the volume, the composition does not react between the light areas associated with the multiple solid areas.

### CROSS-REFERENCE TO RELATED APPLICATIONS

This application is a national phase entry under 35 U.S.C. § 371 of International Patent Application PCT/EP2022/053176, filed Feb. 9, 2022, designating the United States of America and published as International Patent Publication WO 2022/171704 A1 on Aug. 18, 2022, which claims the benefit under Article 8 of the Patent Cooperation Treaty to French Patent Application Serial No. FR2101233, filed Feb. 9, 2021.

### TECHNICAL FIELD

This disclosure relates to an optical projection method suitable for three-dimensional (3D) printing in a composition volume, as well as to a 3D printer, using a non-linear photochemical reaction induced by absorption of energy supplied by a light beam in order to modify a photoreactive composition.

### BACKGROUND

The composition to be modified can include various types. This composition can comprise a resin solidifying by polymerization or by photo-crosslinking, a resin with solubility properties that change by photochemistry, proteins solidifying by photo-crosslinking, or metal salts solidifying by photo-reduction, or, more generally, any composition for which a physical (color, mechanical strength, etc.) or chemical property is modified under the effect of a light signal. Any excess of the unmodified composition is dissolved by a suitable solvent after the modification. The modification of the composition is highly localized since the yields of these photochemical reactions result from non-linear chemistry by irradiation or by fluence. For example, the yields of these two-photon absorption-induced photochemical reactions are proportional to the square of the intensity of the laser source used, such that the modification of the composition is highly localized. In other examples, the non-linearity is acquired by a successive photon addition mechanism, or by a threshold polymerization mechanism, or by a non-linear chemistry mechanism.

Patent D1, FR 3023012, describes a 3D printer, in which a laser beam with a suitable wavelength and power is successively focused at points of a reactive composition so that the volumes of the material located at the successive focusing points of the beam are modified by a photochemical reaction induced by two-photon absorption.

In D1, the 3D printer comprises a laser source, a focusing objective lens and a container of composition to be modified resting on a table, with the table being able to be moved in directions orthogonal (directions X, Y) or parallel (axial direction Z) to the direction of propagation of a laser beam produced by the source.

During operation, the laser beam is focused by the objective lens on a focal point located in the composition to be modified, with the power of the beam decreasing further away from the focal point.

Around the focal point, where the power of the light beam is sufficient, the composition is modified locally in order to form a voxel of this composition. A focal volume refers to a composition volume centered on a focal point, in which volume the energy of the light beam is sufficient to trigger the modification of the composition.

In D1, the XYZ table is controlled so that the focal volume associated with the focal point of the beam is moved in the material in order to form voxels one after the other, until the volume of the 3D object to be printed has been solidified. The object is thus printed voxel-by-voxel, firstly in a plane orthogonal to the beam and defined by the X, Y directions, and then plane-by-plane in the Z direction.

As expressed in the prior art of D1, the use of such a 3D printer allows voxels to be printed with dimensions that are less than one micrometer, or even a hundred nanometers with very high resolution, of the order of a few tens of nanometers. Such a printer is thus suitable for producing very small objects, comprising a small number of voxels.

However, for producing objects with dimensions that are at least 1,000 times greater than the dimensions of a voxel, i.e., of the order of one millimeter or more, the printing time becomes very long when very high resolution is sought.

In order to shorten the printing time, D1 proposes a solution for adjusting the dimension of the voxels during printing, thus allowing successive printing of very small voxels and of larger voxels. This technical solution effectively allows the printing time of an object to be accelerated, but to the detriment of the resolution, notably the axial resolution (along the Z axis), in the zones where the voxels are larger. This can be explained since an increase in the lateral dimensions (along the X and Y axes) of the voxels mechanically leads to a reduction in the lateral resolution, but also the axial resolution, as disclosed in document D2 by Hernandez-Cubero, O., entitled, “Advanced Optical methods for fast and three-dimensional control of neural activity,” Paris Descartes University, France (2016).”

Document D3, “Microstereophotolithography using a liquid crystal display as dynamic mask-generator,” by A. Bertsch, S. Zissi, J. Y. Jézéquel, S. Corbel, J. C. André, Microsystem Technologies (1997) 42-47, Springer Verlag 1997, proposes a faster 3D printing method by photopolymerization of 2D images on the surface of the resin. The axial resolution is acquired by stereolithography (layer-by-layer) manufacturing and the addition of an absorbent in order to limit the propagation of light outside the layer. The implementation of this method is also limited to the use of liquid resins in order to be able to move the object being manufactured in the resin when changing layer.

Document D4 by Saha, Sourabh K., et al., entitled, “Scalable submicrometer additive manufacturing,” Science 366.6461 (2019): 105-109, describes the use of a space-time compression technique for acquiring axial resolution when projecting a 2D image into the volume of a photopolymerizable composition. This method requires the use of femtosecond pulse laser sources and cannot be generalized to the other photopolymerization light sources.

Document D5 by Regehly, Martin, et al., entitled, “Xolography for linear volumetric 3D printing,” Nature 588.7839 (2020): 620-624, describes the use of a 3D photopolymerization technique based on the intersection of two light beams with different colors. The first beam projects, without axial resolution, the images to be polymerized into the resin container. The propagation is carried out without a photochemical reaction up to the point of intersection with the second beam, namely a sheet of perpendicular light, which makes the photoinitiator molecules sensitive to the color of the first beam, and therefore allows the axial resolution to be acquired. This method is limited to the use of highly specific photoinitiator molecules and to free-radical polymerization resins. It cannot be generalized to the photo-chemical systems used in the prior art.

Document D6 entitled, “One-Step volumetric additive manufacturing of complex polymer structures” by Shusteff, Maxim, Allison EM. Browar, Brett E. Kelly, Johannes Henriksson, Todd H. Weisgraber, Robert M. Panas, Nicholas X. Fang, and Christopher M. Spadaccini, Science advances 3, No. 12 (2017): eaao5496, describes a new technology involving projecting a 3D volumetric image into the non-linear photoreactive composition container, which allows the printing time to be considerably accelerated. In addition, the projection, and therefore the chemical reaction, occurs inside the composition container itself and not on the surface, so that it is no longer necessary to move the table supporting the composition container or to use a movable sample holder in the composition container. Also, it is now possible to use viscous photoreactive compositions insofar as the projection is carried out inside the composition volume and where it is no longer necessary to move a sample holder in the composition container. For this new technology, manufacturing millimetric objects requires the orthogonal addition of three 2D images in order to acquire the axial resolution by non-linear polymerization only at the sites where the projected irradiation is added. This makes optical assembly complex and limits the 3D geometric shapes that can be printed.

The recent development of non-linear resins, such as those described in document D7, WO 2019/025717, that are optimized for highly localized photopolymerization, such as STTA-UC, allows the development of new ultrafast 3D printers to be contemplated using direct projection of 2D or 3D images into the volume of the resin.

However, the problem concerning the loss of axial resolution linked to the lateral dimension of the light areas to be polymerized still needs to be solved.

### BRIEF SUMMARY

Embodiments of the present disclosure aim to overcome at least one of the disadvantages of the known printing methods and printers described above, and notably the problem of loss of axial resolution in light areas to undergo a reaction by the projection of images.

To this end, the disclosure proposes a method for printing a 3D object in a photoreactive composition volume, which object is defined by a 3D image comprising a plurality of illuminated points,
wherein the printing method comprises the following steps of:
   extracting (ET2) a sequence of partial images, also called mosaics, from the image, with the sequence comprising at least one mosaic, each mosaic comprising a plurality of solid areas and each solid area comprising an illuminated point or a group of adjacent illuminated points; and
   projecting (ET3) the sequence of mosaics in an axial direction (Z) and inside the composition volume, with the projection of each mosaic forming, in the composition volume, a plurality of light areas, with each light area corresponding to a solid area of the projected mosaic and each light area being adapted to generate a photoreaction of an associated composition block;
and the method being characterized in that:
   in a solid area of a mosaic, the number of illuminated points and the distribution of the illuminated points in the solid area are adjusted so that, when the mosaic is projected into the composition volume, the light area associated with the solid area generates the photoreaction of an associated composition block having a desired axial resolution; and
   in the same mosaic, the solid areas of illuminated points are distributed such that, when the mosaic is projected into the composition volume, the composition does not react between the light areas associated with the plurality of solid areas of the mosaic.

The desired axial resolution is a parameter of the method, selected by the user, as a function of the resolution they wish to acquire for the printed physical object.

In the mosaics, the solid areas can assume various shapes, for example, a compact shape, an elongated shape, a hollow shape, etc.

The resolution of a printed object is directly related to the resolution of the optical image projected into the composition for printing. The projection of a digital image comprising solid areas (or groups of illuminated points) comprising a large number of illuminated points in practice results in an optical image with low axial resolution and leads to a printed object with low axial resolution. Furthermore, rather than printing an object by projecting a single digital image resulting in an optical image with low axial resolution in the composition and leading to a printed object with low axial resolution, the disclosure proposes printing the same object by successive projections of partial images (or mosaics) comprising solid areas each comprising a smaller number of illuminated points for maintaining an optimal axial resolution. Indeed, the small solid areas have sufficient irradiation for only polymerizing around their focal points, and their diffracted intensities are too low to trigger a parasitic polymerization reaction degrading the axial resolution, as will be become clearer hereafter. The essential step ET2 of embodiments of the disclosure thus aims to limit the size of the projected solid areas.

According to one embodiment of the method, the image of the object to be printed is a 3-dimensional image, and the mosaics and the solid areas in the mosaics are also 3D.

According to another embodiment, the method can comprise an initial step (ET1) involving cutting the 3D image of the 3D object to be printed into a series of 2D images representing the object to be printed in planes parallel to each other and perpendicular to the axial direction of image projection in the composition volume, and in that it comprises the following steps ET2 to ET4, repeated for each 2D image and involving:
extracting (ET2) the sequence of mosaics from the 2D image and projecting (ET3) the sequence of mosaics in the axial direction in a focal plane located in the photoreactive composition volume and perpendicular to the axial direction; and
moving (ET4) the focal plane in the composition volume.

This embodiment allows stratum-by-stratum printing of the 3D object directly in the composition volume, and not on the surface of the composition, as is the case with conventional methods of layer-by-layer stereolithography. Furthermore, moving the focal plane in the composition avoids moving the object being printed in the composition volume. It thus becomes possible to use viscous, or even solid, compositions. Furthermore, reinforcements no longer need to be used to retain a fragile object being printed when it moves in the composition.

The disclosure also proposes a printer suitable for implementing a printing method as described above, the printer notably comprising:
a container (2) (which may also be referred to, herein, as a “composition container”) containing a photoreactive composition volume, for example, a photopolymerizable resin solidifying via a non-linear polymerization mechanism; and
an image projector (10) arranged to project a focused image, with a desired axial resolution, into the composition volume,
the printer also comprising means arranged for implementing the printing method as described above, the means comprising a generator (15) for generating a sequence of mosaics arranged to extract, from the image of the object to be printed, a sequence of mosaics and to provide the projector with the sequence of mosaics in order to carry out the projection step ET3.

The image projector is selected with lateral and axial optical resolutions adapted to the desired lateral and axial resolutions for the object to be printed.

### BRIEF DESCRIPTION OF THE DRAWINGS

Further features and advantages of embodiments of the disclosure will become apparent upon reading the detailed description of embodiments of the disclosure, which are provided solely by way of an example, and with reference to the accompanying drawings, in which:

FIG. 1 schematically shows a printer according to embodiments of the disclosure;

FIG. 2 schematically shows an essential step of a printing method according to embodiments of the disclosure;

FIG. 3 (including, therein, FIG. 3a, FIG. 3ay, FIG. 3az, FIG. 3b, FIG. 3by, and FIG. 3bz) shows the results of tests for better understanding the essential step of embodiments of the disclosure; and

FIG. 4 (including, therein, FIG. 4a, FIG. 4az, FIG. 4b, and FIG. 4bz) shows other results of tests for better understanding the essential step of embodiments of the disclosure.

### DETAILED DESCRIPTION

### Definitions

A digital image of a physical object to be printed is defined by a plurality of illuminated points distributed in a matrix comprising illuminated points and non-illuminated points, with the illuminated points defining the object to be printed. A flat object can be represented by a matrix of two-dimensional (2D) points, the points of which matrix are commonly called pixels. A three-dimensional (3D) volumetric object can be represented by a matrix of three-dimensional points, the points of which matrix are commonly called voxels.

By convention, the adjective “adjacent” will be used to refer to two elements that are side-by-side and are touching; for example, in an image or a matrix representing an image, adjacent points touch on one side.

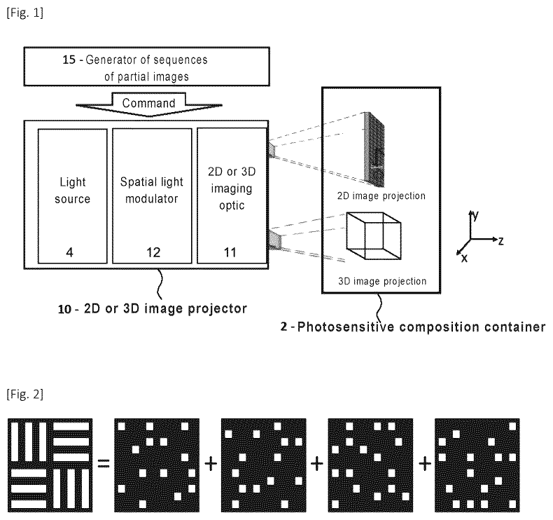

Also by convention, an axial direction Z is defined as being a direction of projection of an image by a projector into a composition volume, and two lateral directions, X, Y, are defined that are perpendicular to each other and perpendicular to the axial direction Z (see the coordinate system in FIG. 1).

The term “composition volume” conventionally means the contents of a container containing the composition, with the composition volume being delimited by the edges of the container.

The term “projection in a composition volume” is understood to mean a projection of an image inside the composition volume, and not a projection under the surface of the composition volume, as is commonly carried out according to conventional stratum-by-stratum (stereolithography) printing methods.

A “solid area” comprises an illuminated point or a group of adjacent illuminated points in which each illuminated point is adjacent to at least one other illuminated point from the same group. For the purposes of the disclosure, the size of a compact solid area is considered to correspond to its average diameter, and the size of an elongated solid area is considered to correspond to its average width.

A spacing between two solid areas is a spacing measured (in millimeters, micrometers, nanometers, etc.) between an illuminated point located on an edge of one of the solid areas and an illuminated point located on an edge of the other one of the solid areas. The distance between two solid areas is the minimum value of the spacings between two solid areas.

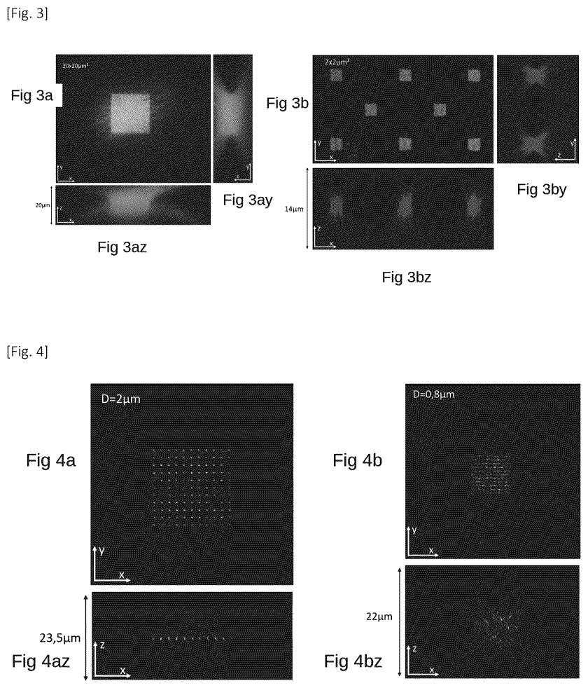

A “light area” is understood to mean an illuminated area in the composition when projecting a solid area of illuminated points, where the light intensity is sufficient to generate a reaction from the composition. A light area is generally larger than an area in which a solid area is projected, as will be seen hereafter in the examples in FIGS. 3 and 4, due to the propagation of the light beam beyond the projection area.

A mosaic is a partial digital image of the overall digital image of a real object; a mosaic is extracted from a (complete) image of the object; a mosaic is the same size, in terms of the number of illuminated points, as the digital image from which the mosaic is extracted; a mosaic comprises only a portion of the illuminated points of the image from which the mosaic is extracted.

The optical “axial resolution,” also called the optical “axial length,” of a light beam is the distance in the direction of propagation between two opposite points of a maximum peak intensity that corresponds to half the maximum intensity. The optical “lateral resolution” of a light beam is the distance, in a lateral direction perpendicular to the direction of propagation, between two opposite points of a maximum peak intensity that corresponds to half the maximum intensity. Finally, for a photoreactive composition, the “resolution of the photoreaction” is determined by the optical resolution of the light beam generating the photoreaction; it can be smaller or larger than the optical resolution of the light beam, depending on the type of composition and the irradiation conditions higher than the minimum irradiation necessary for the photoreaction.

### Detailed Description of Embodiments of the Disclosure

As previously stated, the disclosure relates to printing 3D objects by projecting images into a photoreactive composition volume, the modification of the composition of which is located in the intense irradiation sites. The disclosure more specifically proposes a method for printing a 3D object in a photoreactive composition volume, with the object being defined by a 3D image comprising a plurality of illuminated points.

The printing method according to embodiments of the disclosure comprises the following steps of:
extracting (ET2) a sequence of partial images, also called mosaics, from the image, with the sequence comprising at least one mosaic, each mosaic comprising a plurality of solid areas and each solid area comprising an illuminated point or a group of adjacent illuminated points; and
projecting (ET3) the sequence of mosaics in the photoreactive composition volume in an axial direction (Z) and inside the composition volume, with the projection of each mosaic forming, in the composition volume, a plurality of light areas, with each light area corresponding to a solid area of the projected mosaic and each light area being adapted to generate a photoreaction of an associated composition block.

A solid area can be two-dimensional (X, Y) or three dimensional (X, Y, Z), depending on whether the mosaic that contains the solid area is two- or three-dimensional.

FIG. 3 shows the influence of the dimensions of the solid areas on the optical resolution required to acquire the axial resolution of the composition block transformed after projecting an image of solid areas. The projected image was generated by the holographic projection of the spatial phase modulation of the laser beam, using a Zeiss *100 Aplan NA=1.3 microscope objective lens. FIG. 3a and FIG. 3b show the XY projections, FIG. 3ay and FIG. 3by show the YZ projections and FIG. 3az and FIG. 3bz show the XZ projections of the images acquired with a CMOS camera at various axial positions around the XY focal plane in which the images are projected.

FIG. 3a shows an optical image comprising a single light area resulting from the projection of a digital image comprising a single square solid area. The light area corresponding to the solid area, measuring 20 μm*20 μm, is clearly defined in the X, Y projection plane (FIG. 3a); however, it is very widely spread over the Y, Z plane (FIG. 3ay), as in the X, Z plane (FIG. 3az) on either side of the focal plane in the axial direction Z and in directions that are highly diffracted relative to the axial direction Z. The optical axial resolution is 22 μm, whereas the axial resolution of an optical solid area with a single light spot is 0.5 μm.

FIG. 3b shows an optical image comprising light areas resulting from the projection of a digital image comprising a plurality of smaller square solid areas, fairly spaced apart from one another; the distance between two light areas is 10 μm in the X, Y projection plane. Each light area, measuring 2 μm*2 μm in the X, Y, Z coordinate system (FIG. 3b), remains very light in the direction Z (FIG. 3by and FIG. 3bz) over a depth that is substantially equal to the X, Y dimensions (2 μm) of the light area, with the depth defining the axial resolution of the printed object. Beyond this, the light intensity is lower and is not sufficient to cause a reaction of the composition.

FIG. 4a, FIG. 4b, FIG. 4az and FIG. 4bz show the influence of the distance between solid areas each comprising an illuminated point on the light areas resulting from projecting the solid areas, and therefore the influence of the distance on the reaction of the illuminated composition. The tests are carried out in this case with the same projection optical system as that of the tests shown in FIG. 3.

FIG. 4a, FIG. 4b, FIG. 4az and FIG. 4bz are results of projection tests of a digital image comprising a plurality of equidistant solid areas, with the projections of the solid areas measuring 0.25 μm*0.25 μm, in the X, Y projection plane, and measuring 0.5 μm along Z. These dimensions, acquired with solid areas at an illuminated point, correspond to the best XYZ resolutions that can be acquired for the points focused at the diffraction limit, i.e., with perfect focusing, imposed by the features of the optical system that is used.

When the solid areas are separated from one another by a distance of 2 μm in the projection plane, the light areas that they generate are very sharp and distinct from one another, both in the projection focal plane (FIG. 4a) and along the axial X, Z plane (FIG. 4az). Between the light areas, the light intensity is low and insufficient to cause a modification of the composition.

When the solid areas are only separated from one another by a distance of 0.8 μm in the projection plane, the light areas that they generate are not very sharp and are not very distinct from one another in the X, Y projection plane (FIG. 4b). In the axial direction Z, in the X, Z plane (FIG. 4bz) and, more generally, in any plane parallel to the axial direction, the light areas spread to the point of overlapping. At the sites where the light areas derived from two solid areas overlap, the resulting energy can become sufficient to trigger a reaction of the composition. This is followed by a significant degradation of the axial resolution, as well as an unwanted reaction of the composition between the solid areas where the light beams overlap.

In other words, if two solid areas in an image to be projected are too close to each other, during projection, adding their diffracted light can be enough to trigger an unwanted reaction of the composition.

The method, according to embodiments of the disclosure, has been deduced based on these tests and observations, allowing rapid printing and having a desired axial resolution.

The printing duration is reduced by carrying out steps ET2 and ET3 described above, which steps allow, based on a decomposition into mosaics, which are partial images of the object to be printed, simultaneous printing of multiple illuminated points, instead of printing them one at a time, which makes printing considerably faster.

The desired axial resolution for the printed object is retained by appropriate distribution of the illuminated points in the mosaics and in the solid areas of the mosaics:
in a solid area of a mosaic, the number of illuminated points and the distribution of the points illuminated in the solid area are adjusted so that, when projecting the mosaic into the composition volume, the light area associated with the solid area generates the photoreaction of a composition block having a desired axial resolution; and
in the same mosaic, the solid areas of illuminated points are distributed in such a way that, when projecting the mosaic into the composition volume, the composition does not photoreact between the light areas associated with the plurality of solid areas of the mosaic.

The decomposition of solid areas into mosaics according to embodiments of the disclosure thus results from a compromise.

In a solid area, the number of illuminated points and the distribution of the illuminated points in the solid area (i.e., the shape of the flat) must be optimized. The number of illuminated points must be as large as possible in order to project the least possible number of mosaics in order to print the complete object. At the same time, the number of illuminated points must be limited and the distribution of the illuminated points in a solid area must be optimized in order to maintain the desired axial resolution. The distribution of the illuminated points is expressed by the shape of the solid area.

Furthermore, in the same mosaic, the solid areas must be optimally distributed. The distance between two solid areas must be minimized so that the number of illuminated points in a mosaic is as large as possible. At the same time, the distance between two solid areas must be sufficient to prevent the composition from reacting between two solid areas.

Tests carried out under the test conditions shown in FIGS. 3 and 4 demonstrate that, in a mosaic, solid areas that are smaller than the desired axial resolution and are preferably twice as small, yield good results in terms of axial resolution.

Other tests carried out under the test conditions shown in FIGS. 3 and 4 demonstrate that, in a mosaic, solid areas distributed so that a distance between edges of two solid areas is greater than the desired axial resolution, and is preferably three (3) times the desired axial resolution, yield good results.

The experiment also demonstrates that the decomposition of the image into a mosaic is facilitated by the choice of solid areas assuming general shapes such as:
a compact shape, for example, a disk, a solid ball, a square, a cube, etc. For the purposes of the disclosure, the size of such a solid area is considered to be its average diameter;
an elongated shape, for example, an elliptical shape, an oblong shape, a cylinder, a bar, etc. For the purposes of the disclosure, the size of such a solid area is considered to be its average width; or
a hollow shape, for example, a ring, a hollow sphere, a hollow cylinder, a hollow rectangle, etc.

The method according to embodiments of the disclosure can be used to produce an object to be printed having macroscopic properties and having a desired lateral (XY) and/or axial (Z) resolution of the details that can be greater than 10 μm.

The method also can be used to produce an object to be printed having microscopic properties having a desired lateral (XY) and/or axial (Z) resolution of the details that can be less than 10 μm.

FIG. 2 shows, by way of a simple example, the decomposition of an initial 2D image into a sequence of four 2D mosaics, with the 2D image and the mosaics comprising 24*24 pixels (2D light points). In this simple example, the solid areas of the initial 2D image comprise 2*10 pixels, and the decomposition is such that the solid areas in the mosaics comprise at most 2*2 illuminated points. The decomposition of images according to embodiments of the disclosure into sequence of mosaics similarly applies to the decomposition of a 3D image representing a 3D object and defined by a three-dimensional matrix.

Also, in the simplified example of FIG. 2, where the solid areas in the initial image comprise at most 20 adjacent illuminated points, a decomposition into four mosaics only allows mosaics to be acquired that comprise solid areas comprising at most 4 illuminated points. Of course, for larger objects to be printed, for example, of the order of 1 to 10 millimeters, represented by larger images, for example, images of the microscopic or macroscopic images defined by a matrix of 10,000*10,000 pixels (in 2D) or by a matrix of 10,000*10,000*10,000 voxels (in 3D), the number of mosaics in a sequence can quickly become high, even if solid areas comprising more than 1 illuminated point are acceptable. The number of mosaics will thus in practice depend on the density of the object to be printed or, in other words, on the number of illuminated points and the size of the initial solid areas in the initial image representing the object to be printed, and on the desired resolution for the printed object.

The step ET2 of extracting the sequence of mosaics can be carried out by trial-and-error, by selecting solid areas with simple shapes in line with the general shape or the local shapes of the object to be printed.

For any objects, step ET2 can be carried out iteratively. For the first mosaic, a first version (ET21) alternatively comprising an illuminated point and a non-illuminated point can be tested with the composition to be modified and the associated optical means. Depending on the depth of composition that reacted, and on the possible presence of composition that reacted in unwanted areas, points may or may not be illuminated (ET22). Steps ET21 and ET22 are repeated until a satisfactory first mosaic is acquired. Then steps ET21 and ET22 are repeated for the following mosaics.

The distance between solid areas and the distribution of the solid areas in each mosaic, as well as the number and the distribution of the illuminated points in each solid area of a mosaic as a function of the desired axial resolution for the object to be printed, must be characterized by tests with the selected projection means and photoreactive composition.

For example, tests carried out under the hardware conditions (projection means and choice of composition) of the experiment described in document D2 demonstrate that the axial resolution of a spot (modified composition element) acquired by holographic projection is equal to 1.6 times the diameter of the projected solid area. In other words, in order to acquire, for the object to be printed, an axial resolution equal to 16 μm, 8 μm or 1.6 μm, the maximum dimension of an isotropic solid area is selected so as to be equal to 10 μm, 5 μm or 1 μm.

According to one embodiment of the method, each illuminated point of the image of the object is present in at least one solid area of a mosaic; the successive projection of each of the mosaics of the sequence of mosaics thus allows the entire object to be formed in the composition volume. If each illuminated point is present in a single mosaic, all the points will be projected once when projecting the sequence of mosaics; this allows a printed object to be acquired that is made of a homogeneous material. An illuminated point present in several mosaics will be projected as many times, which amounts to increasing the projection time of the point, and therefore increasing the conversion rate of the composition; this allows, for example, a physical or chemical property of the printed object to be strengthened locally.

According to another embodiment, at least one mosaic is projected several times, successively offset in the axial direction and/or in a focal plane (XY) in the composition volume. This embodiment allows parallel bars to be printed, for example.

According to another aspect of the disclosure, it is possible to associate a first desired axial resolution with a first portion of a mosaic and at least one second desired axial resolution with at least one second portion of the mosaic. This is notably advantageous for producing an object for which:
very fine resolution is required locally, for example, on the edges of the object;
resolution that is not very degraded is acceptable locally, for example, in the center of the object.

The choice of a greater axial resolution depth allows mosaics to be produced that comprise larger solid areas, which allows the number of mosaics to be reduced. This can be used to produce a lens, for example.

According to yet another aspect, when printing an object, the mosaics of the sequence of mosaics each can be projected for an identical time, which is required for the reaction of the composition. This allows, for example, an object to be produced in a substantially homogeneous material. As an alternative embodiment, the mosaics of the sequence of mosaics are projected during different exposure times; this allows, for example, the mechanical properties of an object to be refined locally.

According to yet another aspect, it is possible to project a mosaic with different intensities for some solid areas or for each solid area (grey scale projection). This can allow the thermal increase in the photo-active effect that appears at the center of the solid areas transformed in certain materials to be compensated.

As previously stated, a method according to embodiments of the disclosure comprises an essential step ET2 of extracting a sequence of mosaics in an image of an object to be printed, and a step ET3 of projecting the sequence of mosaics into the photoreactive composition volume.

In one embodiment where the object to be printed is in 2D (a very thin object), the image to be projected and the mosaics are also in 2D. The mosaics are successively projected in the same focal plane (perpendicular to the axial direction) into the composition volume inside the composition container, so that the object is formed in the composition volume as the mosaics are projected.

In another embodiment, the image of the object to be printed is a 3D image and the mosaics and the solid areas in the mosaics, acquired during step ET2, are also 3D. The 3D mosaics are projected, in the form of a real or holographic 3D image, into the composition volume inside the composition so that the object is formed in 3D in the composition volume as the mosaics are projected.

In yet another embodiment, a 3D object is printed layer-by-layer by the successive printing of adjacent 2D layers. In order to implement this, the method according to embodiments of the disclosure comprises an initial step (ET1) involving cutting the 3D image of the 3D object into a series of 2D images representing the object to be printed in planes parallel to one another and perpendicular to the axial direction of image projection in the composition volume, and it comprises the following steps ET2 to ET4, repeated for each 2D image and involving:
extracting (ET2) the sequence of mosaics from the 2D image and projecting (ET3) the extracted sequence of mosaics in a focal plane located in the photoreactive composition volume and perpendicular to the axial direction; and
moving (ET4) the focal plane in the composition volume.

By way of an example, for objects with microscopic properties, the completed tests demonstrate that the polymerization of a 2D mosaic image can be acquired with an exposure time of one millisecond. One hundred mosaic images need to be used in order to acquire an axial resolution of 1 that is a projection sequence lasting for 0.1 second. Manufacturing a 51 μm high microlens array (100×100 μm²) requires the projection of 10 layers, that is a manufacturing time of 1 second. Thus, manufacturing a 1 mm 2 microstructured surface would be possible in a few minutes, and manufacturing a 1 cm² microstructured surface would be possible in a few hours, instead of a few days with the prior art.

According to an alternative embodiment, the step ET4 of moving the focal plane is carried out:
by moving a container containing the composition volume relative to a projector used to carry out the projection step ET3; or
by moving the projector relative to the container containing the composition volume.

According to another alternative embodiment, the step ET4 of moving the focal plane is carried out by a spatial modulation of an initial light beam produced by a light source of the projector used to carry out the projection step ET3, with the modulated beam integrating information relating to the position of the focal plane. The actual completion of these steps will be described in detail hereafter.

The disclosure also proposes a printer for implementing the method described above, the principle of which is shown in a deliberately simplified manner in FIG. 1. The printer comprises:
container 2 (which may also be referred to herein as a “composition container”) containing a photoreactive composition volume, for example, a photopolymerizable resin solidifying via a non-linear polymerization mechanism;
an image projector 10 arranged to project a focused image, with a desired axial resolution, into the composition volume.

The photoreactive composition is, for example, a photopolymerizable resin solidifying by a multiphoton absorption process, by a photon addition mechanism, by a threshold polymerization mechanism or by a non-linear chemistry mechanism.

The printer according to embodiments of the disclosure also comprises means arranged to implement the printing method as described above, notably a generator (15) for generating a sequence of mosaics arranged to extract, from the image of the object to be printed, a sequence of mosaics and to provide the projector with the sequence of mosaics in order to carry out the projection step ET3.

During printing, the projector 10 projects an image into the composition and the illuminated zones react by forming all or part of the object to be printed.

According to the embodiment of FIG. 1, the projector 10 comprises:
a light source (4) producing, for each mosaic to be projected, an initial beam having parameters suitable for triggering a photoreaction of the composition, the parameters comprising, for example, a power, a wavelength and/or an exposure time;
a spatial light modulator (12), arranged to produce, from the initial beam and the mosaic to be projected, a beam to be projected by the optical device; and
an optical imaging device (11) arranged to focus the beam to be projected in a focal plane associated with the mosaic to be projected.

The means for implementing the printing method can also comprise cutting means, for cutting a 3D image into a series of 2D images representing the object to be printed in planes parallel to each other and perpendicular to the axial direction for projecting an image into the composition volume. The cutting means provide the mosaic generator 15 with the 2D images of the series of 2D images resulting from the decomposition, one after the other.

In order to carry out step ET4, the means for implementing the printing method according to embodiments of the disclosure also comprise means for controlling the positioning of the focal plane.

According to one embodiment, the composition container 2 is placed on a motorized table 3 that is axially translationally movable in the direction of projection of the projector 10, and means for controlling the motorized table are arranged to provide the motorized table with a control signal for moving in the axial direction or in a lateral direction (X, Y). The focal plane in the container is thus moved by moving the container.

According to another embodiment, the composition container 2 is placed on a fixed table, and means for controlling the projector are arranged to provide the projector with a control signal comprising an axial position of a focal plane. Thus, the distance between the container and the projector remains fixed, but the focal plane is moved in the container. In an alternative embodiment, the means for controlling the projector provide the imaging device 11 with the control signal comprising the axial position of the focal plane and the imaging device focuses the beam to be projected in the focal plane inside the composition volume. In another alternative embodiment, the means for controlling the projector provide the modulator 12 (also referred to herein as a “spatial light modulator”) with the control signal comprising the axial position of the focal plane and the modulator produces a phase-modulated beam to be projected integrating information relating to the focal plane.

In a practical embodiment, the printer according to embodiments of the disclosure can be an electro-opto-mechanical machine such as that conventionally used in a photoplotter, in a DLP 3D printer, in an LCD 3D printer, in a printer implementing a microstereolithography method or in a microscope; the machine is shifted from its usual use, and adapted and supplemented by the means for implementing the disclosure, notably: a mosaic image generator 15, a projector 10 and means for controlling the electro-opto-mechanical machine and, if the table is movable, means for controlling the movable table.

Furthermore, the composition container 2 and/or the optical imaging device 11 can be arranged with lateral movement means (in the XY plane) in order to make larger objects by successively projecting several sequences of mosaics in the lateral plane.

Other embodiments can be easily contemplated by a person skilled in the art. For example, in order to extend the manufacturing zone limited by the lateral optical field of an image projector, it is possible to simultaneously use several spatial modulation components or to carry out lateral movements of the optical projector or of the resin container. Furthermore, in order to extend the length of the zone for manufacturing liquid resins, it is possible to axially move an adapted element of the optical projector in the resin container. In order to diversify the mode of depositing resins without using a composition container, it is possible to make localized deposits of viscous or solid resins on functional components or surfaces. It is even possible to use unconventional image projectors based on optical fibers or miniature optical components in order to reach areas to be polymerized that are difficult to access.

In summary, the disclosure proposes a 3D printing method and means for implementing the method, which notably provide the following technical and economic benefits:
the possibility of producing, by volumetric 3D printing, large objects, of the order of 1,000 to 10,000 times the dimensions of a point, with very high axial resolution and in relatively short times, of the order of a few tens of seconds to a few tens of minutes depending on the size of their axial dimension;
the possibility of printing an object directly in a container containing the composition to be modified, without moving the sample holder positioned in the container and on which the object is printed, without using a sample holder and/or without moving the composition container;
viscous, or even solid, compositions can be used; they simply need to be transparent.

1. A method for printing a 3D object in a photoreactive composition volume, the 3D objects defined by a 3D image comprising a plurality of illuminated points, the method comprising:
extracting from the 3D image a sequence of mosaics, the mosaics being partial images, the sequence of mosaics comprising at least one mosaic, each mosaic comprising a plurality of solid areas, each solid area comprising an illuminated point or a group of adjacent illuminated points; and
projecting the sequence of mosaics in an axial direction and inside the photoreactive composition volume, the projection of each mosaic forming, in the photoreactive composition volume, a plurality of light areas, each light area corresponding to one of the solid areas of the projected mosaic, each light area being adapted to generate a photoreaction of an associated composition block;
wherein:
in an individual solid area of an individual mosaic, a number of the illuminated points and a distribution of the illuminated points in the individual solid area are adjusted so that, when the individual mosaic is projected into the photoreactive composition volume, the light area associated with the individual solid area generates the photoreaction of the composition block associated with the individual light area, the photoreaction having a desired axial resolution; and
in the individual mosaic, the solid areas are distributed such that, when the individual mosaic is projected into the photoreactive composition volume, a composition of the photoreactive composition volume does not react between the light areas associated with the plurality of solid areas of the individual mosaic.

2. The method of claim 1, wherein the method produces a printed 3D object having macroscopic properties and having a desired lateral and/or axial resolution of details greater than 10 μm.

3. The method of claim 1, wherein the method produces a printed 3D object having microscopic properties having a desired lateral and/or axial resolution of details less than 10 μm.

4. The method of claim 1, wherein a size of the solid areas is less than the desired axial resolution.

5. The method of claim 1, wherein a distance between edges of two of the solid areas is greater than the desired axial resolution.

6. The method of claim 1, wherein the solid areas individually assume an isotropic shape, an elongated shape, or a hollow shape.

7. The method of claim 1, wherein each illuminated point of the 3D image of the 3D object is present in at least one of the solid areas of at least one of the mosaics, a successive projection of each of the mosaics of the sequence of mosaics allowing the 3D object to be formed in the photoreactive composition volume.

8. The method of claim 1, wherein at least one illuminated point of the 3D image of the 3D object is present in a solid area of at least two of the mosaics.

9. The method of claim 1, wherein at least one of the mosaics is projected several times, successively offset in the axial direction and/or in a focal plane in the photoreactive composition volume.

10. The method of claim 1, wherein a first desired axial resolution is associated with a first portion of a mosaic and a second desired axial resolution is associated with a second portion of the mosaic.

11. The method of claim 1, wherein the mosaics of the sequence of mosaics are projected during different exposure times.

12. The method of claim 1, wherein some of the solid areas of a mosaic are projected with different intensities.

13. The method of claim 1, wherein the 3D image of the 3D object to be printed is a three-dimensional (3D) image and the mosaics and the solid areas in the mosaics are three-dimensional (3D).

14. The method of claim 1, further comprising:
before extracting the sequence of mosaics, cutting the 3D image of the 3D object to be printed into a series of 2D images representing the 3D object to be printed in planes parallel to each other and perpendicular to the axial direction of image projection in the photoreactive composition volume; and
repeating for each of the 2D images:
extracting from the 2D image the sequence of mosaics and projecting the sequence of mosaics in the axial direction in a focal plane located in the photoreactive composition volume and perpendicular to the axial direction; and
moving the focal plane in the photoreactive composition volume.

15. The method as claimed in of claim 14, wherein the step moving the focal plane comprises:
moving a container containing the photoreactive composition volume relative to a projector used to carry out the projection of the sequence of mosaics; or
moving the projector relative to the container.

16. The method of claim 14, wherein the moving the focal plane comprises a spatial phase modulation of an initial light beam produced by a light source of a projector used to carry out the projection of the sequence of mosaics, the modulated beam integrating information relating to a position of the focal plane.

17. A printer for printing a 3D object in a photoreactive composition volume, the 3D object defined by a 3D image comprising a plurality of illuminated points, the printer comprising:
a container containing the photoreactive composition volume;
an image projector arranged to project a focused image, with a desired axial resolution, into the photoreactive composition volume; and
means arranged for implementing the method of claim 1, the means comprising a generator for generating the sequence of mosaics, the generator arranged to extract, from the 3D image of the 3D object to be printed, the sequence of mosaics and to provide the image projector with the sequence of mosaics in order to carry out the projection of the sequence of mosaics in the axial direction and inside the photoreactive composition volume.

18. The printer of claim 17, wherein the image projector comprises:
a light source configured to produce, for each mosaic to be projected, an initial beam having parameters suitable for triggering a photoreaction of a composition of the photoreactive composition volume, the parameters comprising a power, a wavelength, and/or an exposure time;
a spatial light modulator arranged to produce, from the initial beam and the mosaic to be projected, a beam to be projected by the optical device; and
an optical imaging device arranged to focus the beam to be projected in a focal plane associated with the mosaic to be projected.

19. The printer of claim 17, wherein:
the printer is configured to:
before extracting the sequence of mosaics, cut the 3D image of the 3D object to be printed into a series of 2D images representing the 3D object to be printed in planes parallel to each other and perpendicular to the axial direction of image projection in the photoreactive composition volume; and
repeat for each of the 2D images:
extracting from the 2D image the sequence of mosaics and projecting the sequence of mosaics in the axial direction in a focal plane located in the photoreactive composition volume and perpendicular to the axial direction; and
moving the focal plane in the photoreactive composition volume; and
wherein, for the printer to be configured for moving the focal plane, the means arranged for implementing the method further comprise:
means for controlling a motorized table supporting the container, arranged to provided the motorized table with a control signal for moving in the axial direction or in a lateral direction; and/or
means for controlling the image projector, arranged to provide the image projector with a control signal comprising an axial position of the focal plane.

20. The method of claim 1, wherein:
a size of the solid areas is twice as small as the desired axial resolution; and/or
a distance between edges of two of the solid areas is greater than three times the desired axial resolution.
